(19) United States
(12) Patent Application Publication
(10) Pub. No.: US 2022/0004960 A1
(43) Pub. Date: Jan. 6, 2022

(54) MACHINE UTILIZATION SYSTEM

(71) Applicant: Ordr Inc., Santa Clara, CA (US)

(72) Inventors: Sheausong Yang, Saratoga, CA (US); Gnanaprakasam Pandian, Cupertino, CA (US); Vijayaraghavan Doraiswami, Santa Clara, CA (US)

(73) Assignee: Ordr Inc., Santa Clara, CA (US)

(21) Appl. No.: 16/921,307

(22) Filed: Jul. 6, 2020

(51) Int. Cl. G06Q 10/06; G06F 11/34; G06F 11/30

(52) U.S. Cl. CPC G06Q 10/06393; G06F 11/3006; G06F 11/3452

(57) ABSTRACT

Systems and methods described may deduce that a machine is in use for a period of time preceding and/or subsequent to a detected operation. The deduction of the usage period may be based on a type of the detected operation. The system may deduce that a machine is in-use during a period of time that spans from (a) a first point-in-time when a first type of operation was detected to (b) a second point-in-time when a second type of operation was detected.

### TECHNICAL FIELD

The present disclosure relates to systems for monitoring machine usage. In particular, the present disclosure relates to a machine utilization system that accurately determines active usage periods associated with a machine.

### BACKGROUND

“Utilization” measures the proportion of actual productive time of a piece of equipment relative to a total amount of time that the equipment could be productive. Utilization data is vital when making informed strategic and tactical business decisions that encourage profitability and manage business cycles. Measurement systems that collect these data are generally adapted for capital-intensive industries in which the capital goods are expensive and either easily tracked or fixed in place. For example, semiconductor processing involves hundreds of different tools that are stationary and whose productivity is easily quantified in terms of batches processed per unit time. In another example, aircraft fleet utilization is easily measured based on per-aircraft capacity utilization (the number of tickets sold per available seats) and the number of aircraft that are operating during a period of time. Even the largest airline fleets include only several hundred airplanes. Given this relatively small number and the limited number of locations where aircraft are permitted to be present, aircraft utilization data collection is straightforward.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for determining machine usage periods in accordance with one or more embodiments;

FIG. 2A illustrates an example set of operations for determining machine usage periods in accordance with one or more embodiments;

FIG. 2B illustrates an example set of operations for determining a machine utilization statistic in accordance with one or more embodiments;

FIGS. 3A, 3B, and 3C schematically illustrate example circumstances contributing to machine usage periods in accordance with one or more embodiments;

FIGS. 4A, 4B, 4C and 4D are example timelines illustrating the various machine usage periods in relation to detected machine events and periods of machine unavailability;

FIG. 5A illustrates a machine reservation system that may be used in communication with utilization systems of the present disclosure in accordance with one or more embodiments;

FIG. 5B illustrates an example machine utilization graphical output for a group of machines over a measurement period in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. MACHINE OPERATION TYPE IDENTIFICATION AND UTILIZATION MONITORING
4. EXAMPLE EMBODIMENTS
5. COMPUTER NETWORKS AND CLOUD NETWORKS
6. MISCELLANEOUS; EXTENSIONS
7. HARDWARE OVERVIEW

1. General Overview

One or more embodiments deduce usage periods for a machine based on the detection of operations corresponding to the machine. The in-use period or usage period for the machine may include human usage, occupancy of the machine itself or physical space where the machine is located. The usage period for a machine does not necessarily require that an operation, corresponding to the machine, is being executed.

The system may deduce that a machine is in use for a period of time preceding and/or subsequent to the detected operation. The deduction of the usage period may be based on a type of the detected operation. The system may deduce that a machine is in-use during a period of time that spans from (a) a first point-in-time when a first type of operation was detected to (b) a second point-in-time when a second type of operation was detected.

The system may deduce non-usage periods based on a calendar corresponding to the machine. As an example, if access to a room that includes the machine is only available from 8 am to 5 pm on a particular day, then the system may deduce a non-usage period prior to 8 am and subsequent to 5 pm on that particular day.

In some examples, the system may monitor utilization of one or more different types of medical devices used in a health care facility or across multiple health care facilities in a health care system. For example, utilizations of capital equipment (e.g., magnetic resonance imagers, positron emission tomography scanners, X-ray machines) as well as more numerous, lower costs devices (e.g., patient monitors, ultrasonic imagers, analytical equipment such as centrifuges, ovens, sample testing equipment) may benefit from the systems and methods described herein. As will be appreciated, the techniques may be applied to network-connected devices that reside at a fixed location or mobile devices that may be used in any of a variety of locations.

One or more embodiments described in this Specification and/or recited in the claims may not be included in this General Overview section.

2. Architectural Overview

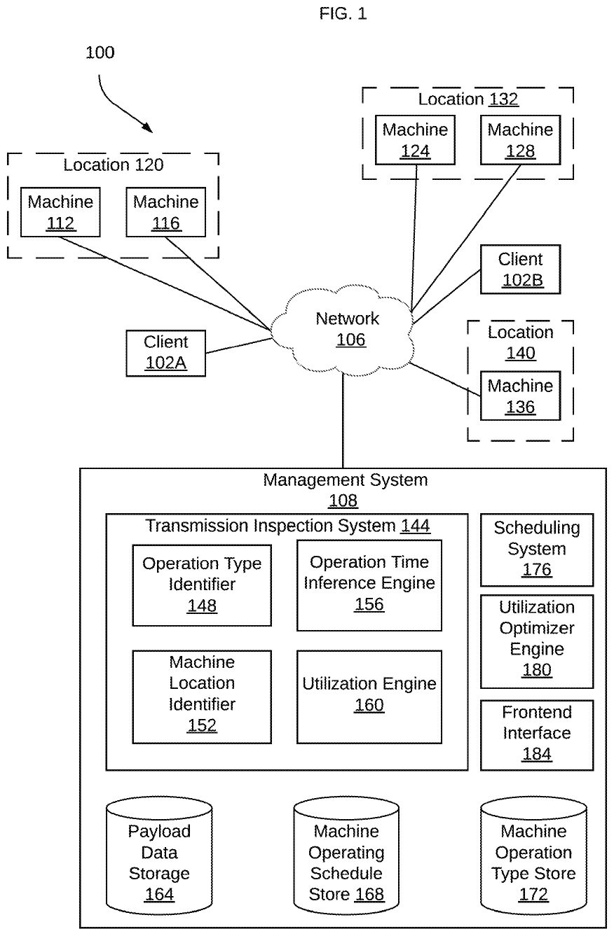

FIG. 1 illustrates an example system 100 in accordance with one or more embodiments. In one or more embodiments, the system 100 refers to hardware and/or software configured to detect execution of an operation by a machine and infer a period of usage (and/or non-usage) associated with the operation. The inferred (or equivalently estimated or deduced) usage period may not be directly reflected in data associated with the operation. For example, the system 100 may deduce or otherwise associate a period of usage corresponding to the detected operation that includes set up, calibration, or reconfiguration of the machine. Often these tasks are not reflected in data generated by execution of the operation or accounted for in traditional utilization measures. These omissions result in data too inaccurate for effective management of the machine.

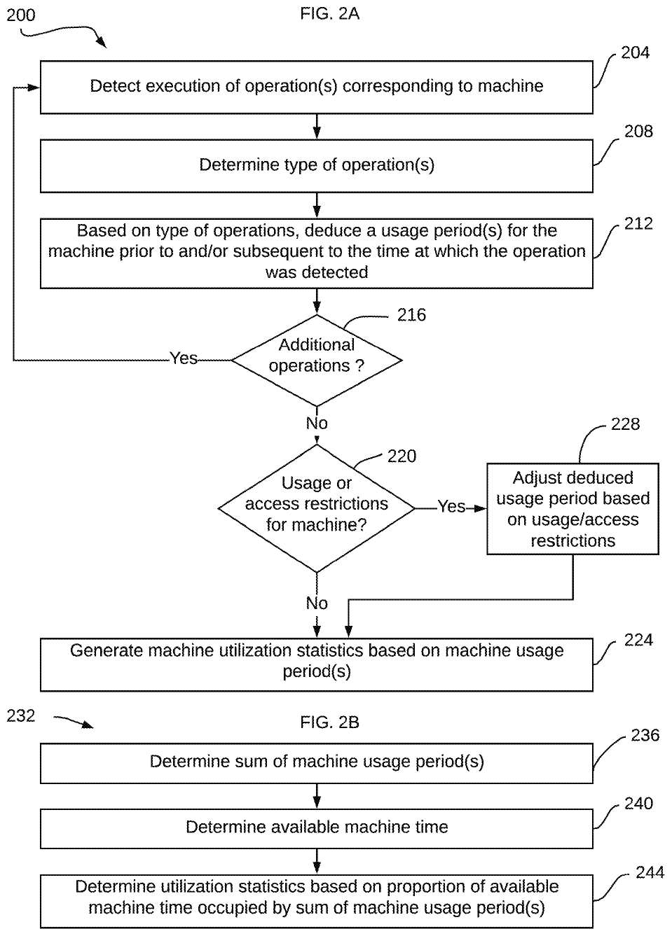

The ability of the system 100 to detect an accurate utilization period associated with an operation improves utilization statistics generated for the machine. This in turn improves the ability to make decisions involving the machine. Examples of these decisions are, for example, the adjustment of machine capacity to match demand, staffing decisions (both in terms of daily/weekly scheduling and the number of staff members), scheduling preventative maintenance, and/or the physical distribution of devices between multiple operation locations. Examples of operations executed by the system 100 are described below with reference to FIGS. 2A and 2B.

In one or more embodiments, the system 100 includes clients 102A, 102B, network 106, management system 108, and machines 112, 116, 124, 128, 136. The system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Clients, such as clients 102A, 102B, may be devices, programs, or applications that enable a user to communicate with the management system 108. Some versions of clients 102A, 102B may be instantiated as a component of a machine or as a control system and/or data collection system of a machine, thereby enabling a machine to communicate with the management system 108. In other examples, clients 102A, 102B enable a human user to interact with the management system 108 to execute queries and/or see usage periods and/or utilization data collected and/or generated by the management system 108.

Examples of clients 102A, 102B include a web browser, mobile application, or other software application communicatively coupled to a network. A client may interact with cloud services using one or more communication protocols, such as HTTP and/or other communication protocols of the Internet Protocol (IP) suite.

The network 106 enables communication between the management system 108 and the machines 112, 116, 124, 128, 136. More specifically, transmissions (e.g., data packets transmitted using a corresponding packet network transmission protocol) reporting execution of an operation by one or more of the machines 112, 116, 124, 128, 136 may be transmitted from the machine to the management system 108 via the network 106. Similarly, scheduling data, diagnostic analysis, software updates, security updates, and the like may be transmitted to or from the machines 112, 116, 124, 128, 136 via the network 106.

Examples of the network 106 include those described below in Section 6, titled “Computer Networks and Cloud Networks.” Additional embodiments and/or examples relating to computer networks are also described below in Section 6.

The machines 112, 116, 124, 128, 136 can be any type of machine, and in particular any type of machine that performs network-detectable operations. Example machines include, but are not limited to, manufacturing devices (e.g., ovens, furnaces, presses, deposition systems, photolithography machines), computer devices (e.g., servers, network devices, computers), and medical devices. Examples of medical devices include, but are not limited to, imagers (e.g., X-ray, magnetic resonance imagers (MRIs), ultra-sonic imagers), analytical devices for measuring compositions, among others.

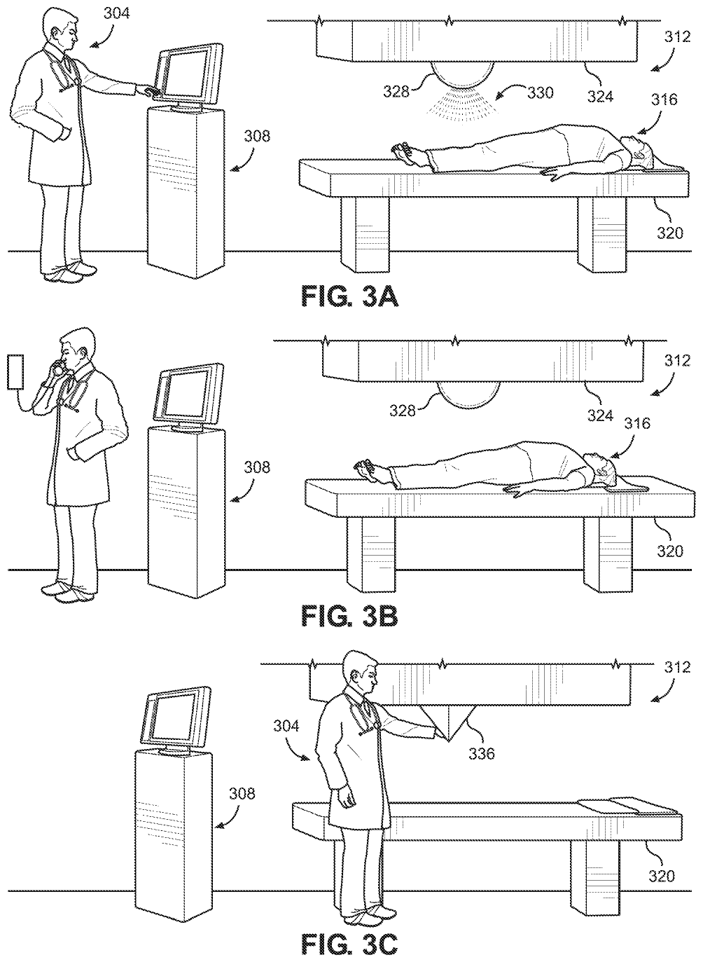

An example of a medical device machine embodying various techniques of the present disclosure is described below in the context of Section 4 and FIGS. 3A, 3B, 3C, 4A, 4B, 4C, 4D, 5A, and 5B. While not limiting the scope of the present disclosure, a medical device illustrates the distinction between operations (i.e., “active use” of a machine) that can be detected by analyzing network transmissions and the inactive use that should be accounted for when analyzing utilization of a machine. Some of these “inactive” tasks, such as calibration, re-configuration, data validation, machine set up, and machine disinfection, may be generically describes as “system maintenance” tasks. Other inactive tasks are simply workpiece manipulation or production material setup that are necessary for productive use of the machine. These latter tasks include positioning a patient on a machine, supplying reagents or raw materials to an analytical testing device, among others. Many of these “inactive time” tasks are required for productive activity of the machine but are not generally associated with a detectable network transmission. As a result, many of these tasks are not accounted for when determining machine utilization.

As shown in FIG. 1 and described above, the machines 112, 116, 124, 128, 136 are connected to the network 106. This enables data generated by the machines 112, 116, 124, 128, 136 to be transmitted via the network 106 to the system 108. The system 108 may then analyze, present, and/or store the data.

When connected to the network 106, the machines 112, 116, 124, 128, 136 may periodically indicate the status of their network connectivity using any of a number of techniques. For example, an element of the system 100 may periodically ping the machine 112, 116, 124, 128, 136 and wait for a reply to determine whether the machines are actively communicating with the network. Alternatively, the machines 112, 116, 124, 128, 136 may transmit their status to a network management appliance to verify their connectivity. The machines 112, 116, 124, 128, 136 may also indicate their performance status. For example, a particular machine may indicate that it is connected to the network 106 but is unable to execute operations because of a machine fault, lack of activity (i.e., transitioning to a low power state), or other reason.

While useful for other system and network operations, these periodic status indicators are insufficient for accurately assessing machine utilization or generating utilization statistics. This is because these status indicators merely indicate the ability (or inability) of a machine to operate and not whether a machine is actively executing an operation. As described below, embodiments of the present disclosure overcome this deficiency by executing transmission (e.g., packet) analysis to identify a type operation executed and deduce a more accurate time associated with the operation.

In addition to transmitting their network and/or performance status, the machines 112, 116, 124, 128, 136 may also transmit data generated from an executed operation via the network 106. These transmissions may include a timestamp (e.g., in a packet header) indicating a time of data transmission or a start time and/or an end time of the operation. Neither of these types of timestamp is able to capture the time required by the machine to execute all tasks associated with the operation with enough accuracy to generate meaningful utilization statistics. A machine may need to be calibrated, set up, or reconfigured before or after an operation is executed. Generally, none of these tasks are likely to be reflected in data associated with execution of the operation itself. Furthermore, machine differences (e.g., older versions of a machine that involve a lengthier calibration and/or reconfiguration) may add further imprecision to these data.

The machines 112, 116, 124, 128, 136 are illustrated as being distributed among multiple different locations. Specifically: the machines 112, 116 are at location 120; the machines 124, 128 are at location 132; and the machine 136 is at location 140. This illustration highlights the physically distributed nature of some machines that can be monitored by the management system 108. Furthermore, as described herein, the management system 108 may be used to make decisions regarding the physical distribution of machines. More specifically, the utilization statistics generated by the management system 108 may be analyzed to improve machine utilization for one or more machines at one or more locations.

While only five machines are shown in FIG. 1, one advantage of embodiments described herein is that the management system 108 can detect operations, deduce usage periods, and generate utilization statistics for tens, hundreds, or even thousands of machines. Furthermore, the plurality of machines may be of many different types. This scale and diversity of machines may be found in manufacturing environments, medical environments (e.g. a hospital or health care network), or other similar environment. Absent embodiments of the present disclosure, effectively managing machine resources in these complex environments is nearly impossible because of the sheer number of individual machines, the diversity of machine types, and the diversity of operation types executed by the machines.

The management system 108 of the system 100 includes a transmission inspection system 144, payload data storage 164, machine operating schedule store 168, machine operation type store 172, a scheduling system 176, a utilization optimizer engine 180, and a frontend interface 184.

The transmission inspection system 144 is configured to receive network transmissions associated with one or more operations executed by various machines of the system 100. In the embodiment shown, the transmission inspection system 144 includes an operation type identifier 148, a machine location identifier 152, an operation time inference engine 156, and a utilization engine 160.

In one example, the transmission inspection system 144 analyzes packets transmitted by one or more of the machines 112, 116, 124, 128, 136 via the network 106. The transmission inspection system 144 identifies a packet network communications protocol and/or encoding scheme used by a machine to generate and transmit data. The transmission inspection system 144 may then use these identified schemes to inspect and/or decode the packet.

The transmission inspection system 144 may analyze transmissions to determine the operation executed by a machine and infer a corresponding usage period. The transmission inspection system 144 may also identify other information in one or more transmissions that may be used to improve utilization statistics associated with one or more machines.

For example, the illustrated embodiment of the transmission inspection system 144 includes an operation type identifier 148, a machine location identifier 152, an operation time inference engine 156, and a utilization engine 160.

The operation type identifier 148 may inspect transmissions to identify a type of operation performed by the machine. For example, the operation type identifier 148 may be configured to execute a packet inspection for data in a packet that indicates an operation type. This operation type may be associated with one or more rules by which inferences may be made (by other elements of the transmission inspection system 144 described below) as to the usage time associated with the operation. For example, different types of operations may be associated with rules that add time before the operation or after the operation. Other types of operations may be associated with rules that link different types of operations together in a single usage period (e.g., serial operations of defined types within a certain window of time). These rules and their assignments to various operation type identifiers are stored in the operation type identifier 148.

The machine location identifier 152 may analyze transmissions to identify a location of a machine that has executed an operation. As shown in FIG. 1, machines are distributed between locations 120, 132, and 140. This illustrates an embodiment of the system 100 in which an environment includes multiple devices at different locations. These locations may be different rooms, different rooms on different floors of a same building, or even different buildings whether on a single campus or at multiple different campuses. Location information may be used by the management system 108 to identify machine usage patterns and make corresponding machine distribution and staffing decisions.

In still other embodiments, the machine location identifier 152 may also detect an identifier of a machine itself (e.g., a MAC ID, serial number). Machine identification data may be used by other elements of the management system 108 to optimize machine utilization. For example, for institutions in which multiple devices of a same type are distributed at different locations (e.g., machine 112 at location 120, machine 124 at location 132), machine identity may be used to more accurately understand machine utilization patterns at these different locations.

In other examples, the machine identity may also be used to more accurately determine machine usage periods. This is because different devices may have different usage periods even when the devices perform the same operation. For example, machine 112 and machine 116 may both perform knee MRI operations. But the machine usage periods of these devices may differ because one of the devices may have a longer set up time, a longer calibration time, or a slower execution of the operation Similarly, different devices may be of different generations or different manufacturers, and therefore have different usage times associated with the same operation. For at least these reasons, the machine identity may be used as a component of the inference of a corresponding usage period.

The operation time inference engine 156 may receive operation type data from the operation type identifier 148. In some examples, the operation time inference engine 156 may also receive machine identity and machine location data from the machine location identifier 152. One or more of these data types may be used by the operation time inference engine 156 to estimate or otherwise determine a length of a usage period associated with various operations performed by the machine. Example techniques for this estimation process are described.

The utilization engine 160 receives estimates for estimate usage periods from the operation time inference engine 156 and compares the estimated usage times to designated maximum times that a machines is available for operations within a measurement period. The maximum operating times may be stored in machine operating schedule store 168, described below. Regardless, one example of a utilization calculation divides a sum of estimated usage times within a measurement period (e.g., a day, a week, a month, a quarter) by a period of available machine time during the measurement period. As described below in more detail, the available machine time is not merely the total number of hours in the measurement period, nor the total time that a machine is functionally connected to a network. While both of these measurements are commonly used in existing utilization calculations, both overstate the actual time that a machine is available. Instead, the utilization engine 160 determines the total available machine time on additional factors to produce more accurate utilization statistics, as described below.

In one or more embodiments, the payload data storage 164, the machine operating schedule store 168, and the machine operation type store 172 are all data repositories. These data repositories may be any type of storage unit and/or device (e.g., a file system, database, collection of tables, or any other storage mechanism) for storing data. Further, these data repositories may include multiple different storage units and/or devices. The multiple different storage units and/or devices may or may not be of the same type or located at the same physical site. Further, any of these data repositories may be implemented or may execute on the same computing system as the management system 108. In some embodiments, the payload data storage 164, the machine operating schedule store 168, and the machine operation type store 172 may be implemented or executed on a computing system separate from the management system 108. These data repositories may be communicatively coupled to the management system 108 via a direct connection or via a network (e.g., the network 106).

The payload data storage 164 provides a location in which payload data associated with transmissions from one or more machines 112, 116, 124, 128, 136 may be stored for reference and/or analysis. Upon receipt of a transmission, the payload data generated by the machine as a result of the execution of machine operations is copied and/or otherwise stored in the payload data storage 164. The machine operating schedule store 168 stores time periods available for machine operation during a measurement period (e.g., a work shift, a day, a week, a year, and/or combinations thereof). As indicated above, the available periods are determined based on a number of factors and are not merely based on a number of hours in a day or a number of days in a year.

The machine operation type store 172 stores different types of operations that each of the machines 112, 116, 124, 128, 136 are capable of performing. The different types of operations are stored with an index that records operation type identifiers and/or indicators that are found in transmission metadata. This index then enables the type of operation to be detected based on metadata accompanying payload data in a transmission from a machine to the management system 108. The machine operation type store 172 may also store machine profiles that are linked to different machine types, machine identities (e.g., manufacturer, year of manufacture, model), and/or operation types. For example, a transmission may identify a particular machine using a machine identifier. The machine identifier may be associated with certain types of machines, corresponding operation types and/or specific operations and usage periods that corresponding to the operation types and/or specific operations. This may serve as a supplement or an alternative to operation type determination and accurate usage period determination.

The scheduling system 176 provides functions that enable one or more of machines 112, 116, 124, 128, 136 to be reserved for use. Not only does the scheduling system 176 enable users to reserve machine time when desired, the data recorded by the scheduling system 176 may be used by other elements of the management system 108 to understand utilization patterns across machines and locations, optimize utilization, and coordinate with machine operator schedules.

The utilization optimizer engine 180 may access various elements of the management system 108 to determine and provide suggestions for increasing utilization of one or more of the machines 112, 116, 124, 128, 136 across the system. For example, the utilization optimizer engine 180 may prompt users (e.g., via a user interface generated by scheduling system 176) to schedule operations using machine 116 at location 120 if machine 112 at the same location is already occupied.

In other embodiments, the utilization optimizer engine 180 may provide data to users that suggests consolidation of machines, relocation of machines to different locations, and/or staffing suggestions based on machine usage periods throughout a measurement period.

In one or more embodiments, frontend interface 184 refers to hardware and/or software configured to facilitate communications between a user (e.g., a client 102A, 102B) and the management system 108. Frontend interface 184 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of frontend interface 184 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the frontend interface 184 is specified in one or more other languages, such as Java, C, or C++.

In an embodiment, the management system 108 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

3. Machine Operation Type Identification and Utilization Monitoring

FIG. 2A illustrates an example set of operations for identifying a type of operation performed at a machine, deducing a usage period associated with the type of operation performed, and generating utilization statistics for the machine, in accordance with one or more embodiments. One or more operations illustrated in FIG. 2A may be modified, rearranged, or omitted all together. Accordingly, the particular sequence of operations illustrated in FIG. 2A should not be construed as limiting the scope of one or more embodiments.

An example method 200, illustrated in FIG. 2A begins with detecting execution of one or more operations corresponding to a machine (operation 204). In some examples, an operation can be detected upon receipt and inspection of a transmission from a machine. As indicated above, the system performs an inspection of a transmission to determine if the transmission is associated with execution of an operation or is merely an indication of network connectivity or machine status.

For example, in many cases data transmitted by a machine is encoded in a packet and transmitted via a packet transmission protocol. The packets may include “payload” data corresponding to the data collected by the machine during execution of the operation for which the machine is configured. The packets may also include “header” data. The header data is used to transmit data describing the transmission itself (e.g., error checking data, packet sequence, frame sequence) as well as other data used by various other elements of the system. For example, encoded within the header may be one or more of an identifier of a machine that performed the operation (e.g., MAC ID), a machine name or type (e.g., a manufacturer name and machine model number and/or serial number).

The system may detect execution of an operation by a determining whether or not a transmitted packet includes payload, or more specifically includes data corresponding to an executed operation. In some examples, the system may execute a deep packet inspection of a packet to identify the presence of this information. For example, the system may execute a deep packet inspection, decode a packet, and/or analyze packet and/or frame metadata to identify information associated with the execution of an operation.

In one example, the system may detect an operation by first identifying a protocol used to generate and/or encode data as a packet and encode payload. One example of a packet standard is the “digital imaging and communications in medicine” or “DICOM” standard commonly used to encode and transmit medical data. Other standards and/or protocols (e.g., TCP/IP) may also be used. Regardless, identification of a protocol and an inspection and/or interpretation of a packet using the protocol by the system may be used to detect whether the machine has executed an operation. In other embodiments, non-packet network systems and protocols may be adapted to embodiments of the present disclosure.

Upon the system detecting an operation, the system may then determine a type of operation (or types of operations) executed by a machine (operation 208). For example, the DICOM standard (or other appropriate standard) may be used to identify in the payload data any of a variety of types of medical operations conducted by the machine. These identifications may be performed at one or more levels of specificity. In one example, at a level of least specificity, the system may determine that a packet includes information relating to a medical imaging operation. At a next level of specificity, the system may determine that the medical imaging operation was a magnetic resonance imaging (“MRI”) operation. At a still more specific level, the system may determine a portion of a patient body on which the MRI operation was performed (e.g., head, chest, knee).

The system may determine one or more of these levels of specificity in operation types by using various levels of transmission analysis and/or inspection. In some examples, the system may also reference other sources of data in the system to determine an operation type. For example, the system may identify image files associated with a transmission and without further analysis infer that an imaging operation was performed. To identify the operation with more specificity, the system may inspect the packet to determine more specific operation type data (e.g., as may be indicating using the DICOM standard) or to determine a machine identity (e.g., via a MAC ID). A machine identity may be linked to certain operations using machine profiles and/or rules.

In one example of using machine identity to increase specificity of a detected operation, the system may identify that an executed operation was an X-ray imaging operation. An identifier encoded in the transmission and corresponding to the machine that executed the operation may be associated with a machine profile and/or an operation type profile. This profile, in turn, indicates that the machine is an X-ray machine, thus allowing an inference to be made as to the operation. The machine profile (or DICOM operation data) may include even more specific data indicating that the X-ray operation type was a dental X-ray.

Once the system determines a type of operation executed, the system may then deduce, infer, or otherwise estimate a usage period associated with the operation (operation 212). The usage period may add a duration of time before, during, and/or after the time at which the operation was detected. This usage period inference improves the accuracy and usefulness of utilization statistics by accounting for system maintenance, workpiece preparation, and/or other time required to perform the operation that is not necessarily associated with the execution of the operation itself.

Particular usage periods may be associated with different operations and may be based on empirical data. For example, it may be known (either in advance or empirically) that before performing a particular operation, a machine will require 15 minutes of set-up, 15 minutes of calibration, and 15 minutes of work piece set up. None of this time would generally be captured in data transmissions from the machine, which would generally include a timestamp indicating an operation start time and an operation end time (e.g., corresponding to data collection by a medical device). In the case of some imaging techniques (e.g., X-ray), this may only be a few seconds or a few minutes. This would significantly underestimate the actual time required for the operation and therefore be insufficient for precise, accurate, or complete machine utilization statistics. Embodiments of the present disclosure may add these durations to the time identified by the data transmission to more accurately reflect the actual usage time.

Similarly, in some cases a machine requires cleaning, disinfecting, or a lengthy shutdown process upon completing execution of an operation. Much like machine set-up, reconfiguration, interim data analysis, and calibration, these post-operation activities do not generate a data transmission and therefore are not generally accounted for using traditional systems.

As explained above, the deduction or inference of an actual usage time may include reference to a machine identifier. For example, machines capable of performing similar operations but of different technological generations and/or manufacturers may require different amounts of time to perform the various set-ups and/or calibrations. These differences may be accounted for using, among other techniques, a series of rules by which a deduced usage period may be assigned and/or adjusted from a baseline assumption.

Similarly, different locations may also have profiles that can be associated via rules to deduce usage periods. For example, a layout or location of supplies and tools relative to a machine at one location may cause lengthier machine reconfiguration times than for the same machine type at a different location with a more convenience supply layout. A location may be detected either using a machine identifier and associating a particular machine with a corresponding location, using an IP address that indicates a location (e.g., via a netblock), or by encoding a location into packet metadata. Regardless of the technique, the location itself may be used to deduce the usage period.

After a usage period is deduced, the system may determine whether additional operations from the machine are to be executed (operation 216). For example, additional operations may be detected by simply waiting for a set period of time for additional transmissions. This may be the case in which multiple images are taken sequentially and within a known period of time within one another. In other examples, additional operations may be assumed based on a continued active connection between the machine and the system. This active connection may be assumed based on a machine operator remaining logged into a control system, a machine activity status notification, or based on rules in which additional operations are presumed within a defined period of time based on the determined operation type. Similarly, no additional operations may be detected upon an operator logging out of a user interface associated with the machine, expressly indicating that the operation is complete, or the machine entering a low power state.

If no additional operations are detected, then the system determines whether any usage or access restrictions apply to the machine (operation 220). These restrictions may be limitations in the operation of the machine that may not otherwise be accounted for in utilization statistics. Usage restrictions may include limitations in the operability of the machine itself, whether expected or unexpected. Examples of usage restrictions include planned maintenance of the machine, software updates or upgrades of the machine or an associated control system, maintenance or construction of facilities associated with the machine (e.g., facility cleaning, facility remodeling, electrical system work, internet system work), among others. Examples of access restrictions include limitations in machine operation time that are distinct from the machine itself. Examples of access restrictions include the time outside business hours, holidays, staffing limitations (e.g., operators unavailable during certain times), among others.

If there are not usage or access restrictions to account for, then the system generates machine utilization statistics (operation 224). One example of a utilization statistic is a sum of deduced usage periods during a measurement period divided by a total number of available hours that the machine could have been operated. This ratio provides a rough measure of the proportion of total time that the machine was operated. A measurement period may be a day, a week, a month, a (financial or calendar) quarter, a year, or other selected time period.

In some examples, the system may generate machine utilization statistics for each individual machine. In other examples, the system may generate machine utilization statistics for a group (or “fleet”) of machines. In still other examples, the system may generate machine utilization statistics for any combinations of individual machines of the group in one or more sub-groups of the group.

This last example may be particularly helpful in understanding patterns of utilization of machines as a function of time and/or location. For example, utilization statistics for multiple sub-groups of machines at different locations may be calculated for a measurement period and compared. This comparison may indicate that machines at one location have a lower utilization generally, or at certain times during the measurement period. This comparative information may be used to reallocate machines between different locations, thus matching available machine time with demand at the different locations. This comparative information may also be used to inform staffing decisions so that machine utilization is better aligned with staff availability. Utilization information as a function of time and/or location may also be used to better inform scheduling decisions and/or promotional efforts so that demand is shifted to periods of low utilization, thereby more evenly distributing machine activity throughout the measurement period.

Returning to operation 220, if usage and/or access restrictions are present for the machine(s), then these restrictions are identified and used to adjust the deduced usage period (operation 228). For example, if a facility is closed before a certain time then it is unlikely that a deduced usage period extends before the certain time. Similarly, if machine operators are not available during a certain period of time (e.g., a meal break, after closing time, shift change), then a deduced usage period will be adjusted accordingly. In one example, the system will remove a portion of a deduced usage period that overlaps in time with a usage/access restriction. Similarly, planned maintenance that reduces the available time of a machine can be included in utilization statistics.

Based on any adjustments to the deduced usage period, the system will generate machine utilization statistics as described above (operation 224).

FIG. 2B illustrates an example method 232 by which the system may calculate machine utilization statistics. The system generates a sum of deduced machine usage periods for a measurement period (operation 236). As indicated above, a measurement period may be a shift, a day, a week, a month, a quarter, a year, or any other convenient measurement period. The system then determines available machine times during this measurement period (operation 240). The system may adjust a gross measurement of availability (e.g., 7 days a week, 24 hours a day, 12 hours a day) with usage and/or access restrictions thereby improving the accuracy of machine availability. A utilization statistic indicating a proportion of machine availability used may be determined by dividing the sum of the deduced machine usage periods by the adjusted machine availability time for the measurement period (operation 244).

4. Example Embodiments

Detailed examples are described below for purposes of clarity. Components and/or operations described below should be understood as one specific example which may not be applicable to certain embodiments. Accordingly, components and/or operations described below should not be construed as limiting the scope of any of the claims.

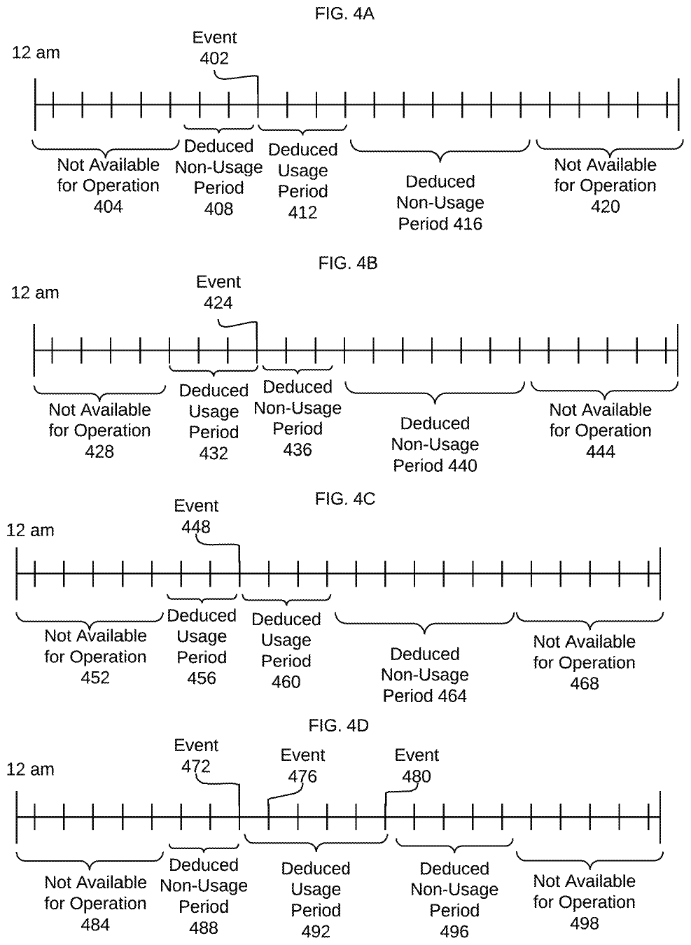

In a first example, FIGS. 3A, 3B, and 3C schematically illustrate scenarios in which a machine operation is not representative of actual machine usage time. FIGS. 4A, 4B, 4C, and 4D present timelines illustrating the deduced usage periods associated with a machine operation that more accurately reflect machine utilization. Various figures of 3A-3C and 4A-4D will be described in coordination with one another for clarity and completeness of explanation.

The FIGS. 3A, 3B, and 3C illustrate an example scenario of a medical technician operating a machine to examine a patient. These figures include a technician 304, a machine workstation 308, a machine system 312, and a patient 316. The machine system 312 includes a machine 324, an imaging module 328, and an examination table 320.

FIG. 3A illustrates the technician 304 operating the machine system 312 via the workstation 308. More specifically, the imaging module 328 is activated to emit radiation 330 to image a portion of the patient 316. While not shown, the imaging module 328 will collect data corresponding to reflected and/or transmitted radiation associated with the examined portion of the patient 316. This data is transmitted to workstation 308 where it can be optionally rendered as an image on the workstation, stored, and/or reformatted or encoded into one or more data packets. These data packets are generally timestamped according to the time at which the data was generated by operation of the machine, which is not indicative of the actual time needed to fully examine the patient 316.

For example, FIG. 3B shows the technician 304 consulting with a colleague by phone. The patient 316 is waiting for the technician 304 on the examination table 320 thereby occupying the machine 312 even though the machine 312 is not actively operating (as indicated by the lack of radiation 330). Even though the machine 312 is not available for use by a different patient, traditional systems of identifying machine utilization would not normally account for this unproductive time as “utilized.” Furthermore, direct measurements of machine use also miss this required, but unproductive, use of the machine because no timestamped data are being generated.

FIG. 3C illustrates another scenario in which required time associated with machine time contributes to a deduced usage period and that would not otherwise be accounted for in traditional utilization measurements. This figure illustrates the technician 304 changing the imaging module 328 to a different imaging module 336. This reconfiguration, required for the next procedure conducted on the machine, would not normally be reflected in utilization statistics. Nor are data being collected, timestamped, and sent to a central data processing system. This lack of data would also generally indicate to traditional systems that the machine 312 is not being utilized.

Unlike these traditional systems, embodiments of the present disclosure do account for required, but not active, times in the machine utilization determination. Various scenarios indicating the more accurate estimation of deduced utilization times are illustrated in FIGS. 4A-4D.

Turning first to FIG. 4A, the timeline indicates an event 402 that occurs within a measurement period (indicated by the demarcated timeline). Periods 404 and 420 indicate times during which a machine is not available for operation. These would coincide with the access/usage restrictions described above in the context of FIG. 2A. For example, facility closures (e.g., period 404 preceding normal working hours and period 420 following normal working hours), lack of operator availability, maintenance, and other similar situations are designated as “not available for operation.” Once designated as such, these time periods 404, 420 may be removed from the total time in which a machine is available for operation. This may in turn generate more accurate utilization statistics, as described above in the context of FIG. 2B.

Embodiments described above in the context of FIGS. 1, 2A, and 2B may deduce a non-usage period 408 and a usage period 412 based on the operation type associated with the event 402. Returning to the scenario shown in FIG. 3A, the system may detect a particular imaging operation as the event 402 (e.g., by performing a packet inspection, identifying a machine). The particular operation may be associated with the deduced usage period 412 because of post-operating cleaning, for example. In this way, the required but unproductive cleaning is accounted for in the planning and utilization analysis associated with the machine. The type of operation associated with the event 402 may also be known to not require machine set up or other preparatory work, and therefore the time period preceding the event 402 may be deduced as a non-usage period 408. Similarly, the deduced usage period 412 may have a defined duration (e.g., 15 minutes, an hour, two hours, three hours). Upon expiration of this deduced usage period 412, any inactivity may be deduced as non-usage period 416.

FIG. 4B illustrates the various periods described above in the context of FIG. 4A, except that a deduced usage period 432 precedes event 424 and a deduce non-usage period 436 follows the event 424. This may be consistent with a system or machine that conducts an operation, collects data, and timestamps the data with the time at which the operation and data collection are complete. In this situation, the time used to generate the data is unaccounted for by the system. As described above, this may be inferred based on the type of operation associated with event 424. The operation type may also be used to deduce non-usage periods 436, 440. Periods 428, 444 in which the machine is not available for operation are analogous to periods 404, 420.

FIG. 4C illustrates the various periods described above in the context of FIG. 4A, except that deduced usage periods 456, 460 precede and follow a detected event 448. This may correspond to a situation in which a machine requires configuration before the event (i.e., deduced usage period 456 before event 448) and then requires reconfiguration, maintenance, or cleaning after the event (i.e., deduced usage period 460 after event 448). The deduced non-usage period 464, and the periods 452, 468 are analogous to those described above.

FIG. 4D illustrates an example scenario in which a usage period includes multiple events. The events 472 and 476, when detected, are associated with corresponding types. These types are then associated with deduced non-usage period 488 and a deduced usage period 492 that includes both events. For example, the events 472 and 476 may be associated with one another so that event 476 is known to be performed after the event 472. The events 472, 476 are known to coincide with usage period 492, thereby accounting for transition time between the two events 472, 476 and any necessary tasks subsequent to the event 476. The deduced non-usage period 496 and the periods in which the system is not available for operation 484, 498 are analogous to those described above.

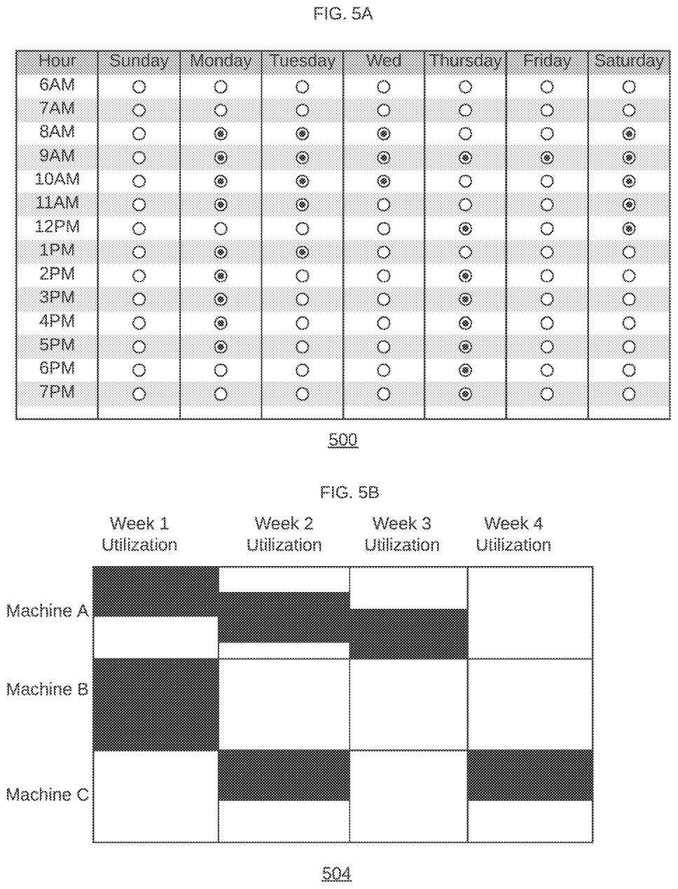

FIG. 5A illustrates an example user interface 500 of a scheduling and/or reservation system that may be used to reserve use of a machine. The example interface 500 enables hourly reservations on a daily basis throughout a week. Reservations are shown as selected radio buttons in this particular interface, although other selection mechanisms are possible. While convenient, these reservations may also fail to accurately reflect usage time because the hourly reservation time may be too much time or too little time to accommodate an operation.

FIG. 5B illustrates an example user interface 504 displaying a utilization summary for three different machines across a measurement period (in this case four weeks). Data in this representation or similar representations may be used to manage any of a variety of decisions regarding the use of machines. Examples of decisions include the physical locations of machines at different locations, the number of machines to operate, staffing, and the like.

For example, the user interface 504 illustrates that Machine A has the highest and most consistent utilization of the three machines being compared. This may suggest that Machines B and C may be reallocated or removed from operation. Alternatively, the machines themselves may be retained, but staffing of the machines reduced so that the overall costs of operating the machines is reduced.

In a second example, the techniques described herein are applied throughout a medical facility (or a health care system that includes multiple medical facilities) to monitor utilizations of groups of machines in which each group includes a same machine type. In this way, the system may monitor aggregated utilization for groups of different machines types. Different machine types are likely to be used in different ways and therefore be associated with different utilization expectations and usage periods. For example, deployed patient monitoring devices are likely to be used nearly 24 hours a day. Expectations for individual patient monitoring devices may be 90% utilization over a usage period of 24 hours a day for seven days a week. For a fleet of many of these devices, utilization may also have a dimension that reflects the proportion of devices of the fleet that are in active use. For example, the system may expect that 85% of all machines in the fleet are in active use at any given time. In contrast, a group of MRI machines, which may have a fleet size of fewer than 10, may be expected to have, collectively, a utilization of 75% over a usage period of 10 hours a day for five days a week.

Utilization for group of a same type of machine may be analyzed by using the techniques above and aggregating machine data based on a machine type. This machine type may be identified using metadata transmitted in a packet header. For example, a MAC ID of a machine may be coordinated with a machine profile. The machine profile may indicate a machine type that includes different individual machines regardless of the model or manufacturer of the different individual machines. Each machine identifier and/or machine profile may be associated with events, deduced usage periods, deduced non-usage periods, and periods in which the machines are not available for operation.

Utilization data may be aggregated for all machines of a same type and analyzed using the techniques described above to generate utilization data appropriate for the type of machine. In this way, utilization statistics may be generated and analyzed on a machine type basis for an entire group of machines.

5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

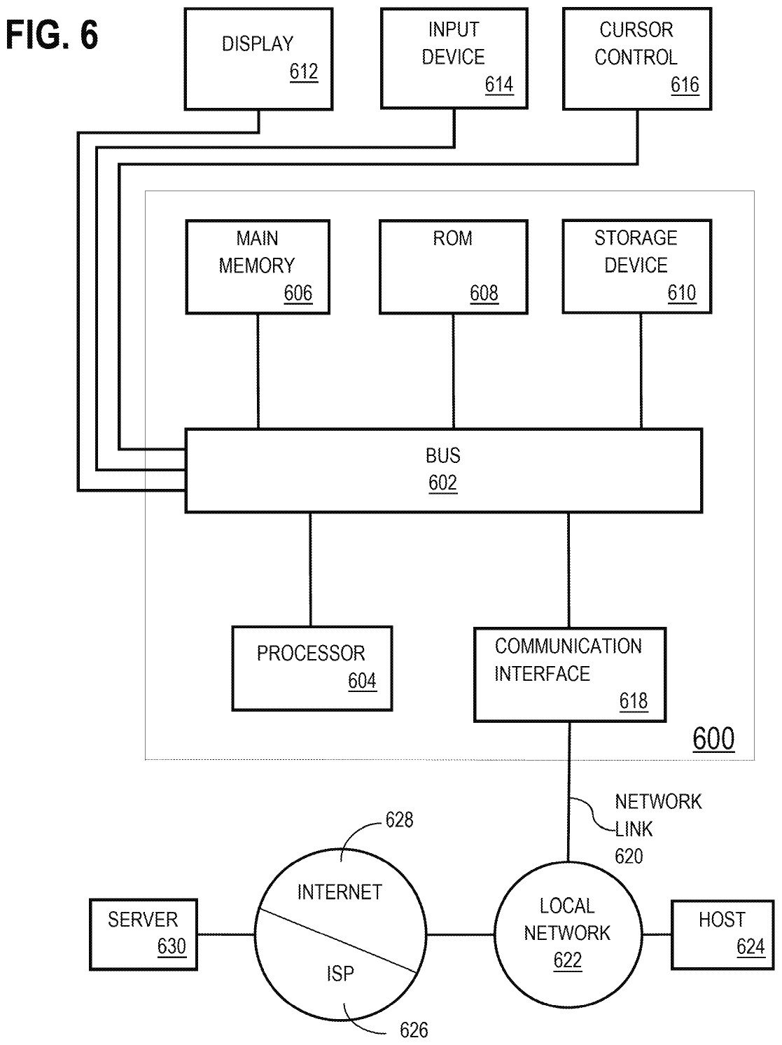

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which when executed by one or more hardware processors, cause performance of operations comprising:
detecting execution of a first operation corresponding to a machine;
determining that the first operation is of a first type;
based at least on the first type of the first operation, estimating a first length of a first machine usage period associated with the machine;
detecting execution of a second operation corresponding to the machine;
determining that the second operation is of a second type;
based at least on the second type of the second operation, estimating a second length of a second machine usage period associated with the machine, wherein the second length is different than the first length; and
generating utilization statistics for the machine based on at least the first machine usage period and the second machine usage period.

2. The one or more media of claim 1, wherein the first operation comprises one of:
an integrated machine performing the first operation; or
one or both of a software component or a hardware component performing the first operation, the software component or the hardware component external to and in communication with the machine.

3. The one or more media of claim 2, wherein the first operation performed by one or both of the software component or the hardware component is a system maintenance operation.

4. The one or more media of claim 1, wherein one or both of the first machine usage period and the second machine usage period precedes the corresponding one of the first operation or the second operation.

5. The one or more media of claim 1, wherein one or both of the first machine usage period and the second machine usage period follows the corresponding one of the first operation or the second operation.

6. The one or more media of claim 1, wherein one or both of the first machine usage period and the second machine usage period both precede and follow the corresponding one of the first operation or the second operation.

7. The one or more media of claim 1, further comprising:
detecting execution of a third operation corresponding to the machine, wherein the first length of the first machine usage period is based on a time interval between the detection of the first operation and detection of the third operation.

8. The one or more media of claim 1, wherein:
detecting execution of the first operation comprises detecting a network transmission associated with the execution of the first operation; and
determining the first type comprises analyzing the network transmission to identify the first operation in metadata associated with the network transmission.

9. The one or more media of claim 1, wherein generating utilization statistics for the machine comprises:
determine sum of the first machine usage period and the second machine usage period;
determining a period of available machine time; and
determining a utilization percentage based on the sum of the first machine usage period and the second machine usage period divided by the period of available machine time.

10. The one or more media of claim 1, wherein the first usage period comprises a duration of the first operation and an added duration associated with execution of the first operation.

11. The one or more media of claim 10, wherein the added duration is based on a type of the first operation.

12. The one or more media of claim 11, wherein the type of the first operation is used to add the added duration to one of before, after, or concurrent with the duration of the first operation to estimate the first usage period.

13. A method comprising:
detecting execution of a first operation corresponding to a machine;
determining that the first operation is of a first type;
based at least on the first type of the first operation, estimating a first length of a first machine usage period associated with the machine;
detecting execution of a second operation corresponding to the machine;
determining that the second operation is of a second type;
based at least on the second type of the second operation, estimating a second length of a second machine usage period associated with the machine, wherein the second length is different than the first length; and
generating utilization statistics for the machine based on at least the first machine usage period and the second machine usage period.

14. The method of claim 13, wherein the first operation comprises one of:
an integrated machine performing the first operation; or
one or both of a software component or a hardware component performing the first operation, the software component or the hardware component external to and in communication with the machine.

15. The method of claim 14, wherein the first operation performed by one or both of the software component or the hardware component is a system maintenance operation.

16. The method of claim 13, wherein one or both of the first machine usage period and the second machine usage period precedes the corresponding one of the first operation or the second operation.

17. The method of claim 13, wherein one or both of the first machine usage period and the second machine usage period follows the corresponding one of the first operation or the second operation.

18. The method of claim 13, wherein one or both of the first machine usage period and the second machine usage period both precede and follow the corresponding one of the first operation or the second operation.

19. The method of claim 13, further comprising:
detecting execution of a third operation corresponding to the machine, wherein the first length of the first machine usage period is based on a time interval between the detection of the first operation and detection of the third operation.

20. The method of claim 13, wherein:
detecting execution of the first operation comprises detecting a network transmission associated with the execution of the first operation; and
determining the first type comprises analyzing the network transmission to identify the first operation in metadata associated with the network transmission.

21. The method of claim 13, further comprising:
identifying the machine as a machine of a first type;
aggregating the generated utilization statistics for the machine with utilization statistics corresponding to a plurality of additional machines of the first type; and
generating fleet utilization statistics for, collectively, the machine and the plurality of additional machines of the first type.
